(19) United States
(12) Patent Application Publication
(10) Pub. No.: US 2025/0037005 A1
(43) Pub. Date: Jan. 30, 2025

(54) SYSTEM FOR DYNAMIC ALLOCATION OF COMPUTATIONAL RESOURCES FOR OPTIMIZED PERFORMANCE OF MACHINE LEARNING MODELS

(71) Applicant: BANK OF AMERICA CORPORATION, Charlotte, NC (US)

(72) Inventors: Elvis Nyamwange, Little Elm, TX (US); Erik Dahl, Newark, DE (US); Brian Neal Jacobson, Los Angeles, CA (US); Pratap Dande, Saint Johns, FL (US); Hari Vuppala, Charlotte, NC (US); Rahul Yaksh, Austin, TX (US); Rahul Shashidhar Phadnis, Charlotte, NC (US); Amer Ali, Jersey City, NJ (US); Sailesh Vezzu, Hillsborough, NJ (US)

(73) Assignee: BANK OF AMERICA CORPORATION, Charlotte, NC (US)

(21) Appl. No.: 18/225,829

(22) Filed: Jul. 25, 2023

(51) Int. Cl. G06N 20/00

(52) U.S. Cl. CPC G06N 20/00

(57) ABSTRACT

Systems, computer program products, and methods are described herein for dynamic allocation of computational resources for optimized performance of ML models. The present disclosure is configured to receive a request to execute a ML model; determine computational requirements associated with the ML model; determine a subset of computational resources from a pool of computational resources to execute the ML model based on the computational requirements associated with the ML model; allocate the subset of computational resources to the ML model; and execute the ML model using the subset of computational resources.

### TECHNOLOGICAL FIELD

Example embodiments of the present disclosure relate to dynamic allocation of computational resources for optimized performance of machine learning (ML) models.

### BACKGROUND

Machine learning (ML) models can vary significantly in their computational resource requirements based on several factors, including the model architecture, the size and complexity of the data, and the specific task at hand.

Applicant has identified a number of deficiencies and problems associated with computational resource allocation based on ML model requirements. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for dynamic allocation of computational resources for optimized performance of machine learning (ML) models.

In one aspect, a system for dynamic allocation of computational resources for optimized performance of machine learning (ML) models is presented. The system comprising: a processing device; a non-transitory storage device containing instructions when executed by the processing device, causes the processing device to: receive a request to execute a machine learning (ML) model; determine computational requirements associated with the ML model; determine a subset of computational resources from a pool of computational resources to execute the ML model based on the computational requirements associated with the ML model; allocate the subset of computational resources to the ML model; and execute the ML model using the subset of computational resources.

In some embodiments, the computational requirements comprise at least processing power, memory, storage, network bandwidth, energy consumption, inference speed, numerical precision, and/or parallelism.

In some embodiments, the pool of computational resources comprises a plurality of processing units, wherein each processing unit comprises a plurality of cores.

In some embodiments, the plurality of processing units comprises at least central processing units (CPUs), graphics processing units (GPUs), tensor processing units (TPUs), field-programmable gate arrays (FPGAs), and/or application-specific integrated circuits (ASICs).

In some embodiments, executing the instructions to determine the subset of computational resources further causes the processing device to: determine a group of cores from the plurality of processing units; allocate the group of cores to the ML model; and execute the ML model using the group of cores.

In some embodiments, the computational resources comprise one or more memory units, wherein the one or more memory units comprises at least a random access memory (RAM), a cache memory, a video RAM, a high bandwidth memory (HBM), a graphics double data rate (GDDR) memory, and/or a unified memory.

In some embodiments, executing the instructions to determine the subset of computational resources further causes the processing device to: determine a group of memory units; allocate the group of memory units to the ML model; and execute the ML model using the group of memory units.

In some embodiments, executing the instructions further causes the processing device to: determine an occurrence of a trigger event during the execution of the ML model; capture information associated with the trigger event; determine an effect of the trigger event on the execution of the ML model; dynamically allocate additional computational resources to the ML model in response to determining the effect of the trigger event on the execution of the ML model; and execute the ML model using the subset of computational resources and the additional computational resources.

In some embodiments, the trigger event comprises at least a change in dataset size, a change in model complexity, convergence issues, memory leaks, increase in concurrency, model assembling, fault occurrences, and/or adversarial attacks.

In another aspect, a computer program product for dynamic allocation of computational resources for optimized performance of machine learning (ML) models is presented. The computer program product comprising a non-transitory computer-readable medium comprising code causing an apparatus to: receive a request to execute a machine learning (ML) model; determine computational requirements associated with the ML model; determine a subset of computational resources from a pool of computational resources to execute the ML model based on the computational requirements associated with the ML model; allocate the subset of computational resources to the ML model; and execute the ML model using the subset of computational resources.

In yet another aspect, a method for dynamic allocation of computational resources for optimized performance of machine learning (ML) models is presented. The method comprising: receiving a request to execute a machine learning (ML) model; determining computational requirements associated with the ML model; determining a subset of computational resources from a pool of computational resources to execute the ML model based on the computational requirements associated with the ML model; allocating the subset of computational resources to the ML model; and executing the ML model using the subset of computational resources.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for dynamic allocation of computational resources for optimized performance of machine learning (ML) models, in accordance with an embodiment of the disclosure;

FIG. 2 illustrates a process flow for dynamic allocation of computational resources for optimized performance of machine learning (ML) models, in accordance with an embodiment of the disclosure; and

FIG. 3 illustrates a process flow for dynamic allocation of additional computational resources in response to a trigger event, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The computational resource requirements for machine learning (ML) models can fluctuate significantly based on several key aspects. For example, the architecture of the model plays a crucial role; more complex models like convolutional neural networks (CNNs) or recurrent neural networks (RNNs) demand greater computational power compared to simpler models such as decision trees or logistic regression, due to their vast number of parameters. Furthermore, the volume and complexity of the data directly impact computational needs. Larger datasets necessitate more memory and processing power. Similarly, the complexity of data, whether it's simple numerical data or more intricate data like high-resolution images or complex natural language data, influences resource requirements. A significant distinction also exists between the resources required during the training phase of a machine learning model, where model parameters are learned, and the inference phase, where the model is used to make predictions. Training typically is more computationally intensive, especially for large datasets and complex models. Some machine learning applications demand real-time or near-real-time predictions, escalating the need for more computational power to ensure timely data processing and prediction generation. The level of numerical precision used in models can also affect computational resource usage; higher precision might enhance accuracy but demands more resources, whereas lower precision, though faster and less resource-intensive, could reduce accuracy. In addition to these, model complexity and depth directly correlate with the computational resources needed; the more complex and deeper the model, the more resources it requires. Finally, some models allow for parallelism or distribution across multiple cores or machines, which can expedite training times, but may also amplify overall computational resource needs. Consequently, designing and deploying ML systems often involves a careful balance between computational resources, model complexity, and performance. As such, there is a need for a system for dynamic allocation of computational resources for optimized performance of ML models.

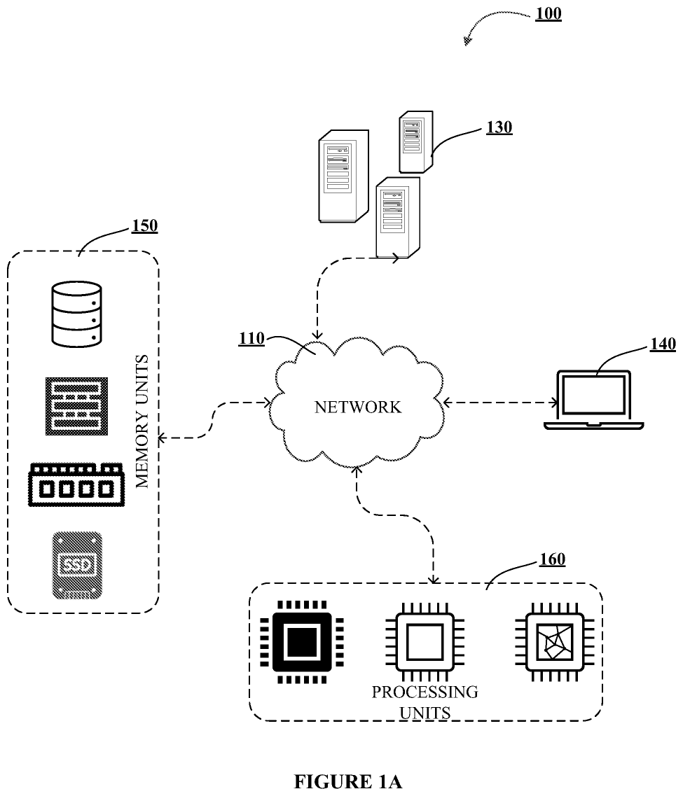

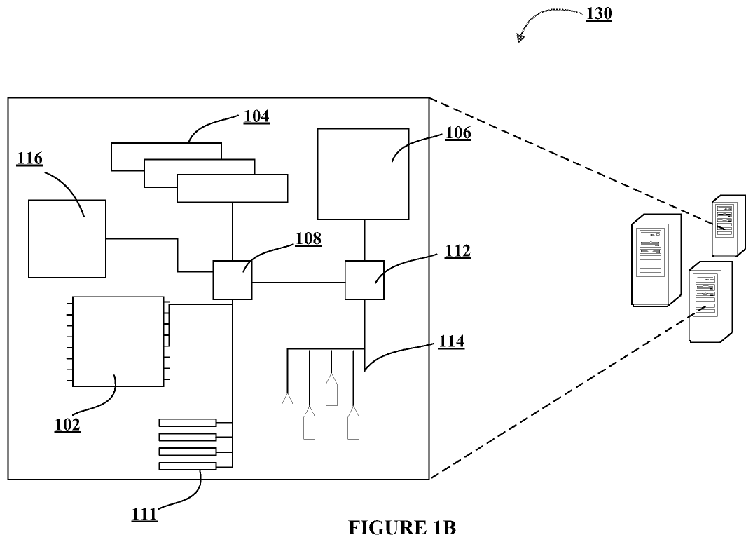

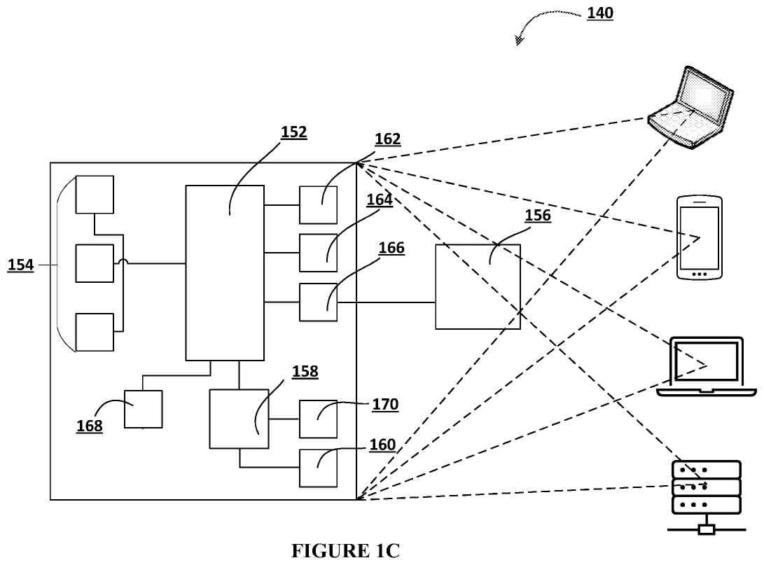

FIGS. 1A-1C illustrate technical components of an exemplary distributed computing environment for dynamic allocation of computational resources for optimized performance of machine learning (ML) models 100, in accordance with an embodiment of the disclosure. As shown in FIG. 1A, the distributed computing environment 100 contemplated herein may include a system 130, an end-point device 140, computational resources, such as memory units 150 and processing units 160, and a network 110 over which the system 130, and the end-point device 140 communicate therebetween. FIG. 1A illustrates only one example of an embodiment of the distributed computing environment 100, and it will be appreciated that in other embodiments one or more of the systems, units, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device 140 may have a client-server relationship in which the end-point device 140 are remote devices that request and receive service from a centralized server, i.e., the system 130. In some other embodiments, the system 130 and the end-point device 140 may have a peer-to-peer relationship in which the system 130 and the end-point device 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

ML models may have different computational requirements based on their complexity, the size of the dataset, and the specific task at hand, and may require specific computational resources for optimized execution thereof. As shown in FIG. 1A, the computational resources may include memory units 150 and processing units 160. The memory units 150 may include a random-access memory (RAM), a cache memory, video RAM (VRAM), high bandwidth memory (HBM), graphics double data rate (GDDR) memory, unified/shared memory, and/or the like. The processing units 160 may include central processing units (CPUs), graphics processing unit (GPUs), tensor processing units (TPUs), field programmable gate arrays (FPGAs), application-specific integrated circuits (ASICs) and/or the like. In a distributed computing environment (e.g., computing environment 100), computational resources (e.g., memory units 150 and processing units 160) may be spread out across multiple nodes, such as various systems, devices, or components that may contribute to the computational power of the entire distributed computing network 100. For example, a node in the distributed computing network 100 could be a server in a data center equipped with powerful CPUs and GPUs. Another could be a less powerful personal computer. Despite their differences, each contributes their processing capabilities to the network. Similarly, the collective memory available in the distributed computing environment 100 may be the sum of the memory available in each individual system or device associated therewith. For example, one node might have a large amount of high-speed RAM ideal for data-intensive tasks, while another might contribute significant disk storage for long-term data persistence.

In some embodiments, the system 130 may be operatively coupled to the computational resources via multiple high-speed interconnects, such as compute express links (CXLs) to improve performance and efficiency within the distributed computing environment 100. These CXLs may be used to allocate (and based on a trigger event, dynamically reallocate) computational resources dynamically and efficiently for executing a task (e.g., executing an ML model). CXL typically includes three main protocols: CXL.io, CXL.cache, and CXL.memory. CXL.io may provide backward compatibility with the prevalent peripheral component interconnect express (PCIe) standard, allowing CXL devices to be plugged into existing PCIe slots. CXL.cache may enable devices connected via CXL to maintain cache coherency with the host device (e.g., system 130, processing units 160, and/or the like) for high-performance computing purposes. CXL.memory may allow devices to access the host device's memory hierarchy, creating a unified memory space capable of being shared. Multiple CXL links allow for better allocation of resources based on the task at hand, ensuring each task is handled by the most suitable device. By allowing direct data transfer, CXL reduces latency and increases the data transfer rate, leading to faster computation and better overall system performance. CXL is scalable with the needs of the distributed computing environment, supporting more devices as needed. The dynamic allocation feature of CXL makes it possible to adapt to changing workloads in real time, which is crucial in a distributed computing environment where demand can fluctuate.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low-speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile RAM having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low-speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device 140, in accordance with an embodiment of the disclosure. As shown in FIG. 1C, the end-point device 140 includes a processor 152, memory 154, an input/output device such as a display 156, a communication interface 158, and a transceiver 160, among other components. The end-point device 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device 140, such as control of user interfaces, applications run by end-point device 140, and wireless communication by end-point device 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device 140 with other devices. External interface 168 may provide, for example, for wired communication in some implementations, or for wireless communication in other implementations, and multiple interfaces may also be used.

The memory 154 stores information within the end-point device 140. The memory 154 can be implemented as one or more of a computer-readable medium or media, a volatile memory unit or units, or a non-volatile memory unit or units. Expansion memory may also be provided and connected to end-point device 140 through an expansion interface (not shown), which may include, for example, a SIMM (Single In Line Memory Module) card interface. Such expansion memory may provide extra storage space for end-point device 140 or may also store applications or other information therein. In some embodiments, expansion memory may include instructions to carry out or supplement the processes described above and may include secure information also. For example, expansion memory may be provided as a security module for end-point device 140 and may be programmed with instructions that permit secure use of end-point device 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device 140 to transmit and/or receive information or commands to and from the system 130 via the network 110. Any communication between the system 130 and the end-point device 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device 140 may provide the system 130 (or other client devices) permissioned access to the protected resources of the end-point device 140, which may include a GPS device, an image capturing component (e.g., camera), a microphone, and/or a speaker.

The end-point device 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device 140, which may be used as appropriate by applications running thereon, and in some embodiments, one or more applications operating on the system 130.

The end-point device 140 may also communicate audibly using audio codec 162, which may receive spoken information from a user and convert the spoken information to usable digital information. Audio codec 162 may likewise generate audible sound for a user, such as through a speaker, e.g., in a handset of end-point device 140. Such sound may include sound from voice telephone calls, may include recorded sound (e.g., voice messages, music files, etc.) and may also include sound generated by one or more applications operating on the end-point device 140, and in some embodiments, one or more applications operating on the system 130.

Various implementations of the distributed computing environment 100, including the system 130 and end-point device 140, and techniques described here can be realized in digital electronic circuitry, integrated circuitry, specially designed ASICs (application specific integrated circuits), computer hardware, firmware, software, and/or combinations thereof.

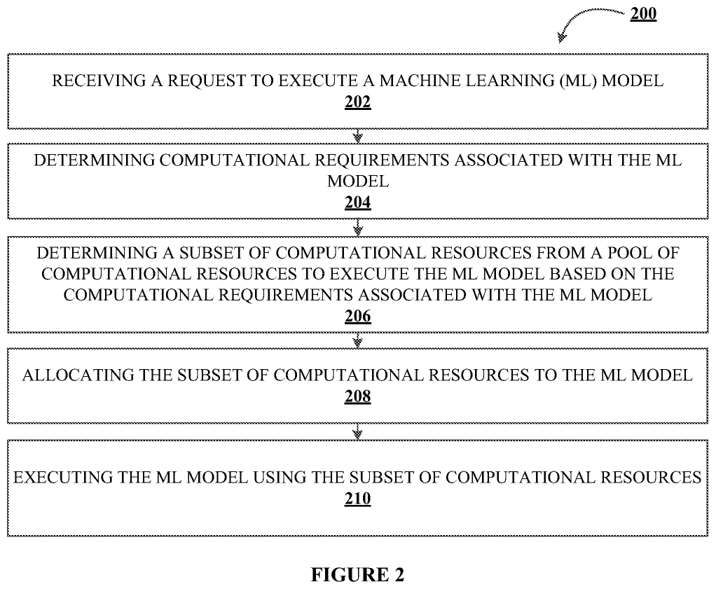

FIG. 2 illustrates a process flow for dynamic allocation of computational resources for optimized performance of ML models 200, in accordance with an embodiment of the disclosure. As shown in block 202, the process flow includes receiving a request to execute a ML model. In some embodiments, the system (e.g., system 130) may receive the request to execute the ML model from a user input device (e.g., end-point device 140). An ML model may be a mathematical representation that enables computers to learn patterns from data and make predictions or decisions without being explicitly programmed to do so. Based on algorithms and training data, ML models may learn to associate features with particular outcomes and make predictions on unseen data. ML models may range from simpler linear regression models to more complex constructs such as deep neural networks. The process of training an ML model involves iteratively adjusting parameters to minimize the difference between the model's predictions and actual data, which is quantified by a loss function. Once trained, the ML model can be used to make predictions on new data. Depending on the specific task, ML models can be used for a variety of purposes, including classifying emails, predicting temporal data points, recognizing speech, or even driving autonomous vehicles. The performance of the ML model may be measured using specific metrics, which vary based on the type of task (e.g., accuracy for classification tasks, mean squared error for regression tasks). Continual learning and adjustment based on new data or feedback is often a crucial aspect of maintaining the performance of the ML model.

As shown in block 204, the process flow includes determining computational requirements associated with the ML model. In some embodiments, computational requirements may refer to the amount and type of computational resources needed to successfully perform a particular task or set of tasks (e.g., executing an ML model). Computational requirements for ML models may depend on a number of factors, including model architecture, data volume, data complexity, type of ML task (e.g., training, inference, and/or the like), real-time requirements, precision requirements, parallelism and distribution requirements, and/or the like.

Complex models such as CNNs or RNNs may demand greater computational power compared to simpler models such as decision trees or logistic regression, due to their vast number of parameters. The volume and complexity of the data may impact computational needs. Larger datasets may necessitate more memory and processing power. Similarly, the complexity of data, whether it's simple numerical data or more intricate data like high-resolution images or complex natural language data, may influence computational requirements. A significant distinction also exists between the resources required during the training phase of a machine learning model, where model parameters are learned, and the inference phase, where the model is used to make predictions. Training may typically be more computationally intensive, especially for large datasets and complex models. Some ML applications may demand real-time or near-real-time predictions, escalating the need for more computational power to ensure timely data processing and prediction generation. The level of numerical precision used in models may also affect computational resource usage; higher precision may enhance accuracy but demand more resources, whereas lower precision, though faster and less resource-intensive, could reduce accuracy. In addition to these, model complexity and depth may directly correlate with the computational resources needed; the more complex and deeper the model, the more resources it may require. Furthermore, some models may allow for parallelism or distribution across multiple cores or machines, which can expedite training times, but may also amplify overall computational resource needs. As such, in example embodiments, the computational requirements may include processing power, memory, storage, network bandwidth, energy consumption, inference speed, numerical precision, parallelism, and/or the like.

As shown in block 206, the process flow includes determining a subset of computational resources from a pool of computational resources to execute the ML model based on the computational requirements associated with the ML model. As described herein, ML models may have different computational requirements based on their complexity, the size of the dataset, and the specific task at hand. Simple models, such as linear regression or decision trees, usually require less processing power, memory, and storage as they are less computationally intensive. They can be trained and deployed effectively even on modest hardware, such as CPUs. On the other hand, more complex models like deep learning neural networks, particularly CNNs for image processing or RNNs for sequential data, often require powerful hardware accelerators like GPUs or TPUs, due to the vast number of matrix operations involved in their computations. As such, in example embodiments, the pool of computational resources may include a plurality of processing units such as CPUs, GPUs, TPUs, FPGAs, ASICs and/or the like.

In some embodiments, each processing unit may include a number of cores. A core may refer to a primary computational component of a processing unit. In some embodiments, each core may be configured to and capable of independently executing instructions, such as arithmetic and logical operations, control operations, and data transfer commands. Modern processing units often have multiple cores (dual-core, quad-core, octa-core, and so on), allowing them to perform multiple operations simultaneously, a feature known as parallel processing. Each core may essentially function as its own processor, capable of managing and executing its own tasks. For example, CPUs can have anywhere from two to 32 cores or even more, and some cores can handle multiple threads simultaneously using hyperthreading technology, GPUs may include hundreds or thousands of smaller cores that are designed to execute tasks simultaneously, making them ideal for workloads that can be parallelized, such as many ML tasks, TPUs may include a large matrix processing unit, which can handle a high volume of low-precision computations in parallel, such as matrix operations in neural network calculations, FPGAs may include a large array of programmable logic blocks (cores) and a hierarchy of reconfigurable interconnects that can be reconfigured to create custom, task-specific cores, and ASICs have architectures that are specifically designed for execution of a particular task.

In some embodiments, the computational resources may include memory units. Memory units are integral in the execution of ML models, both during training and inference stages. For example, during training, the ML model may learn patterns from the data, adjusting its internal parameters based on a loss function. This involves performing numerous calculations, including storing intermediate results, which need to be held in memory. In the case of large-scale ML models like deep learning networks, which might have millions to billions of parameters, the amount of required memory can be substantial. Additionally, memory may be needed to store the training dataset. The larger the dataset, the more memory is typically required. If the dataset is too large to fit into memory, it will have to be loaded in smaller batches, which can affect the training speed and efficiency. During inference, or making predictions with a trained model, memory may be needed to load the model parameters and the input data. While the memory requirements during inference are generally less than during training, they can still be considerable for large models or when making many predictions simultaneously. As such, the memory units such as RAM, cache memory, VRAM, HBM, GDDR memory, a unified memory, and/or the like.

As shown in block 208, the process flow includes allocating the subset of computational resources to the ML model. In this effort, the process flow may include determining a group of cores from the plurality of processing units. Having determined the group of cores, the process flow may include allocating the group of cores to the ML model. In addition, in some embodiments, the process flow may include determining a group of memory units. Having determined the group of memory units, the process flow may include allocating the group of memory units to the ML model.

As shown in block 210, the process flow includes executing the ML model using the subset of computational resources. Once allocated, the process flow may include executing the ML model using the group of cores and the group of memory units. For example, execution of the ML model may involve a training phase and an inference phase. During the training phase, as described herein, the ML model may learn to make accurate predictions by iteratively adjusting its parameters based on the input data and a loss function. The training process often involves a significant amount of computation, which is often parallelizable. The group of cores (e.g., CPU cores, GPU cores, TPU cores, or a combination thereof) is leveraged to carry out these computations. For instance, in a deep learning model, the multiplication and addition of large matrices, which is highly parallelizable, forms the basis of forward and backward propagation stages. Such computation may be distributed among the available cores for optimized processing. In parallel, memory units are heavily used to store the training data, intermediate results, and the model parameters. For instance, when using a batch gradient descent optimization algorithm, a subset (or batch) of the training data is loaded into memory for each step of the training process. The intermediate results of the computations (like the gradients) and the updated model parameters require memory units for storage and processing. The same principles apply during the execution of the inference stage, when the ML model is used to make predictions on new data. The model parameters are loaded into memory, and the group of cores carry out the computations necessary to generate predictions. Through this orchestration of group of cores and group of memory units, the ML model can be executed efficiently.

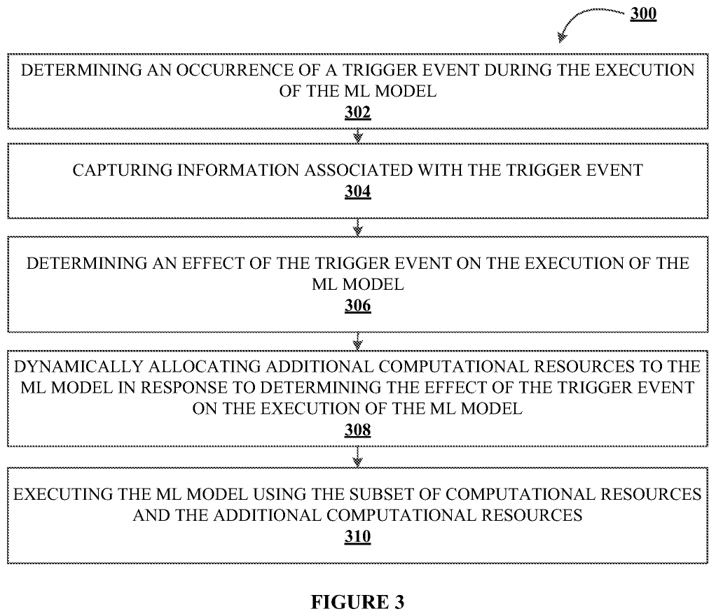

FIG. 3 illustrates a process flow for dynamic allocation of additional computational resources in response to a trigger event 300, in accordance with an embodiment of the disclosure. As shown in block 302, the process flow includes determining an occurrence of a trigger event during the execution of the ML model. In some embodiments, the trigger event may include a change in dataset size. In some cases, during a data gathering setting, where data is continuously collected and fed into the model, if additional data becomes available during execution, it may be incorporated into the model, increasing the computational resources needed. In some other embodiments, the trigger event may include a change in model complexity. During the training process, it is not uncommon for one to increase the complexity of the model—for example, adding more layers or nodes to a neural network—to improve its predictive performance. This will likely increase the need for computational resources. In still other embodiments, the trigger event may include convergence issues. In cases where the model may not be converging as expected, one might need to increase the number of iterations or the time spent in the training phase, which would require more computational resources. In yet another embodiment, the trigger event may include memory leaks, which can suddenly increase the memory demand. In still other embodiments, the trigger event may include an increase in concurrency, where the number of simultaneous requests for predictions or inferences may increase, thus increasing the load on the system, and as a consequence, requiring additional computational resources. Still other trigger events may include model ensembling, fault occurrences, adversarial attacks, and/or the like.

As shown in block 304, the process flow includes capturing information associated with the trigger event. As shown in block 306, the process flow includes determining an effect of the trigger event on the execution of the ML model. In some embodiments, the information associated with the trigger event may include changes in model complexity. For instance, if the complexity of the ML model changes due to additions or modifications (for example, adding more layers to a neural network), the effect of the trigger event on the execution of the ML model may be a need for more processing power or memory. In some other embodiments, the information associated with the trigger event may include changes in dataset size. For instance, if the size of the training or inference dataset increases significantly, the effect of the trigger event may be a need for more memory or storage capacity. In still other embodiments, the information associated with the trigger event may include changes in performance requirements. For instance, if the required speed of training or inference changes (for example, if real-time predictions are suddenly needed), the effect of the trigger event may be more processing power. In yet another embodiment, the information associated with the trigger event may include changes in power or cost constraints, changes in hardware availability, changes in concurrent tasks, and/or the like, with effects such as a need to redistribute the computational load, a need to reduce computational resource usage, and a need for task scheduling or load balancing, respectively.

As shown in block 308, the process flow includes dynamically allocating additional computational resources to the ML model in response to determining the effect of the trigger event on the execution of the ML model. In some embodiments, the additional computational resources may be determined from the existing pool of computational resources. In some other embodiments, the additional computational resources may be determined by reallocating resources from other tasks that have a priority level that is less than a priority level associated with the execution of the ML model. In some example embodiments, each task, including the ML model, may be assigned a priority level. The priority levels are used to indicate the relative importance of each task. Higher priority tasks are generally considered more important than lower priority ones. In situations where the ML model requires additional computational resources than what were initially allocated thereto due to any number of trigger events described herein, the process flow may include reallocating resources from other tasks currently running on the same system that have a priority level that is less than that of the priority level of the ML model.

As shown in block 310, the process flow includes executing the ML model using the subset of computational resources and the additional computational resources.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for dynamic allocation of computational resources for optimized performance of machine learning (ML) models, the system comprising:
a processing device;
a non-transitory storage device containing instructions when executed by the processing device, causes the processing device to:
receive a request to execute a machine learning (ML) model;
determine computational requirements associated with the ML model;
determine a subset of computational resources from a pool of computational resources to execute the ML model based on the computational requirements associated with the ML model;
allocate the subset of computational resources to the ML model; and
execute the ML model using the subset of computational resources.

2. The system of claim 1, wherein the computational requirements comprise at least processing power, memory, storage, network bandwidth, energy consumption, inference speed, numerical precision, and/or parallelism.

3. The system of claim 1, wherein the pool of computational resources comprises a plurality of processing units, wherein each processing unit comprises a plurality of cores.

4. The system of claim 3, wherein the plurality of processing units comprises at least central processing units (CPUs), graphics processing units (GPUs), tensor processing units (TPUs), field-programmable gate arrays (FPGAs), and/or application-specific integrated circuits (ASICs).

5. The system of claim 4, wherein executing the instructions to determine the subset of computational resources further causes the processing device to:
determine a group of cores from the plurality of processing units;
allocate the group of cores to the ML model; and
execute the ML model using the group of cores.

6. The system of claim 1, wherein the computational resources comprise one or more memory units, wherein the one or more memory units comprises at least a random access memory (RAM), a cache memory, a video RAM, a high bandwidth memory (HBM), a graphics double data rate (GDDR) memory, and/or a unified memory.

7. The system of claim 6, wherein executing the instructions to determine the subset of computational resources further causes the processing device to:
determine a group of memory units;
allocate the group of memory units to the ML model; and
execute the ML model using the group of memory units.

8. The system of claim 1, wherein executing the instructions further causes the processing device to:
determine an occurrence of a trigger event during the execution of the ML model;
capture information associated with the trigger event;
determine an effect of the trigger event on the execution of the ML model;
dynamically allocate additional computational resources to the ML model in response to determining the effect of the trigger event on the execution of the ML model; and
execute the ML model using the subset of computational resources and the additional computational resources.

9. The system of claim 8, wherein the trigger event comprises at least a change in dataset size, a change in model complexity, convergence issues, memory leaks, increase in concurrency, model ensembling, fault occurrences, and/or adversarial attacks.

10. A computer program product for dynamic allocation of computational resources for optimized performance of machine learning (ML) models, the computer program product comprising a non-transitory computer-readable medium comprising code causing an apparatus to:
receive a request to execute a machine learning (ML) model;
determine computational requirements associated with the ML model;
determine a subset of computational resources from a pool of computational resources to execute the ML model based on the computational requirements associated with the ML model;
allocate the subset of computational resources to the ML model; and
execute the ML model using the subset of computational resources.

11. The computer program product of claim 10, wherein the computational requirements comprise at least processing power, memory, storage, network bandwidth, energy consumption, inference speed, numerical precision, and/or parallelism.

12. The computer program product of claim 10, wherein the pool of computational resources comprises a plurality of processing units, wherein each processing unit comprises a plurality of cores.

13. The computer program product of claim 12, wherein the plurality of processing units comprises at least central processing units (CPUs), graphics processing units (GPUs), tensor processing units (TPUs), field-programmable gate arrays (FPGAs), and/or application-specific integrated circuits (ASICs).

14. The computer program product of claim 13, wherein, in determining the subset of computational resources, the code further causes the apparatus to:
determine a group of cores from the plurality of processing units;
allocate the group of cores to the ML model; and
execute the ML model using the group of cores.

15. The computer program product of claim 10, wherein the computational resources comprise one or more memory units, wherein the one or more memory units comprises at least a random access memory (RAM), a cache memory, a video RAM, a high bandwidth memory (HBM), a graphics double data rate (GDDR) memory, and/or a unified memory.

16. The computer program product of claim 15, wherein, in determining the subset of computational resources, the code further causes the apparatus to:
determine a group of memory units;
allocate the group of memory units to the ML model; and
execute the ML model using the group of memory units.

17. The computer program product of claim 10, wherein the code further causes the apparatus to:
determine an occurrence of a trigger event during the execution of the ML model;
capture information associated with the trigger event;
determine an effect of the trigger event on the execution of the ML model;
dynamically allocate additional computational resources to the ML model in response to determining the effect of the trigger event on the execution of the ML model; and
execute the ML model using the subset of computational resources and the additional computational resources.

18. A method for dynamic allocation of computational resources for optimized performance of machine learning (ML) models, the method comprising:
receiving a request to execute a machine learning (ML) model;
determining computational requirements associated with the ML model;
determining a subset of computational resources from a pool of computational resources to execute the ML model based on the computational requirements associated with the ML model;
allocating the subset of computational resources to the ML model; and
executing the ML model using the subset of computational resources.

19. The method of claim 18, wherein the computational requirements comprise at least processing power, memory, storage, network bandwidth, energy consumption, inference speed, numerical precision, and/or parallelism.

20. The method of claim 18, wherein the pool of computational resources comprises a plurality of processing units, wherein each processing unit comprises a plurality of cores.
